(19) United States
(12) Patent Application Publication
(10) Pub. No.: US 2004/0204165 A1
(43) Pub. Date: Oct. 14, 2004

(54) Cellular phone with built-in hands-free headset and cellular phone-carrying device with built-in or attached hands-free headset

(76) Inventor: Manqing Huang, San Jose, CA (US)

Correspondence Address: MANQING HUANG, 1129 MIRAMAR WAY ATP. 32, SUNNYVALE, CA, 94086, US

(21) Appl. No.: 10/331,358

(22) Filed: Dec. 30, 2002

(51) Int. Cl. H04B 1/08; H04B 1/38; H04M 1/00

(52) U.S. Cl. 455/569.1; 455/348; 455/575.1

(57) ABSTRACT

A portable electronic device with cellular phone capability has a built-in hands-free headset. A carrying device for a portable electronic device with cellular phone capability has a built-in or attached hands-free headset. The headset is retractable, and is stored in the portable electronic device or the carrying device with a point-of-access externally accessible during periods of non-use, and can be pulled out for telephone conversation. The headset has a cord-winder providing internal storage for the cord. The cellular phone or the carrying device provides readiness of a hands-free headset and convenience of carrying the headset, thus it facilitates the use of hands-free headsets when appropriate.

### CROSS-REFERENCE TO RELATED APPLICATIONS

Not Applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION—FIELD OF THE INVENTION

This invention relates to a cellular phone with built-in hands-free headset, or a cellular phone-carrying device with built-in or attached hands-free headset.

### BACKGROUND OF THE INVENTION

The term “cellular phone” in this application refers to any portable electronic device with cellular phone capability.

Using a cellular phone when driving a vehicle or operating machinery may pose a safety risk to the user and other people. It is recommended, or required by law in some states, to use hands-free option when driving to avoid tying up one hand by holding a cellular phone.

The most commonly used hands-free option is headset. However, it is inconvenient to carry a separate headset, and to set up the headset before driving. If the driver forgets to set up the headset before driving, it is even more dangerous for him/her to set up the headset while the vehicle is in motion. It is also desirable to have a convenient way to store the headset when it is not used. Therefore, there is a need for building a cellular phone or a carrying device for a cellular phone, which eases the use of the hands-free headset. The carrying device can be a case, holster, holder, charger, or any other carrying device.

U.S. Pat. No. 5,845,197 issued on Dec. 1, 1998 to Hada, et al., titled “Portable electronic device with associated earphone”, describes a hands-free headset for portable electronic device. This headset can be attached to the portable device with a pair of holding pawls to keep the headset in position. The headset is not integrated into the portable device so carrying it is not convenient enough. Furthermore, even if the headset is not in use, the whole headset is visible.

U.S. Pat. No. 5,718,310 issued on Feb. 17, 1998 to Gallo, Bruce, titled “Cord winder” describes using of a cord-winder to provide extendable telephone cord. In this invention the cord-winder is placed outside the telephone itself.

U.S. Pat. No. 6,374,126 issued on Apr. 16, 2002 to MacDonald, Jr., et al., titled “Hands-free headset with stowable stereo earpiece”, claims a two earpieces headset with a retractable cord reel and a docking platform mechanically attachable to the portable device. However, the second speaker is unnecessary for a safety oriented cellular phone headset, because devoting two ears to telephone conversation decreases the driver's ability to hear other sounds. Including two speakers with two cords or two electrical paths increases the design complexity and size of the headset, and thus increases the difficulty of integrating the headset into a cellular phone or the cellular phone-carrying device. Further more, in a cellular phone user's perspective, assembling the headset into a separated cellular phone accessory is less convenient than integrating it into a carrying device for a cellular phone; in addition, the included docking platform can be eliminated to further reduce size of the headset or the combination of portable device and headset.

### BACKGROUND OF INVENTION—OBJECTS AND ADVANTAGES

Several objects and advantages of the present invention are:

(a) to provide a cellular phone with built-in retractable hands-free headset, which allows the headset to be readily accessed by the user, and to be conveniently stored inside the cellular phone during periods of non-use.

(b) to configure a compact and aesthetic cellular phone with built-in hands-free headset, so that when the headset is not used, existence of the headset neither significantly changes the exterior of a cellular phone nor affects usage of a cellular phone.

(c) to provide a carrying device for a cellular phone, such as a case, holster, holder or charger, which facilitates electrical connection between a cellular phone and a hands-free headset, and provides instant access to and convenient storage for the headset.

(d) to configure an aesthetic carrying device for a cellular phone and a hands-free headset, so that carrying the headset does not significantly change the exterior of the carrying device.

These objects are satisfied by the present invention.

Particularly, the purpose of providing a ready-to-use heads-free headset is satisfied by the present invention. The first part of the present invention is a cellular phone with a built-in hands-free headset. This headset is hardwired to the cellular phone; obviously an electrical path for phone conversation through the headset is set up without further physical connection. Another part of the present invention is a carrying device for a cellular phone with built-in (or attached-in) hands-free headset. This carrying device has a connector electrically connecting to the headset. This connector couples with the headset outlet of a cellular phone when the phone is properly placed in the carrying device. Therefore, the electrical path for phone conversation through the headset is set up without further physical connection.

Providing a built-in retractable hands-free headset satisfies the purpose of providing convenience of carrying the headset. The headset comprises a cord-winder. The cord-winder allows the cord of the headset to be pulled out, rewinds and stores the cord when the cord is released. With a point-of-access externally accessible, the headset, together with its cord-winder, is stored inside the cellular phone body or inside a carrying device during periods of non-use. With a single earpiece and no docking-platform, the integrated configuration facilitates compact and aesthetic embodiments.

The present invention is advantageous, because it facilitates immediate access and storage of a ready-to-use hands-free headset. This invention provides a more compact configuration than existing solutions for cellular phone headset users.

### SUMMARY

In accordance with the present invention, a cellular phone comprises a cellular phone body and a built-in retractable hands-free headset. The headset is stored in the cellular phone body during periods of non-use with a point-of-access externally accessible. The earpiece and microphone can be pulled out whenever needed. The embedded headset portion has a cord-winder to receive the retractable cord for internal storage of the headset.

In accordance with the present invention, a cellular phone-carrying device has a built-in or attached retractable hands-free headset. Within the carrying device, there is a connector to couple with the cellular phone headset outlet. This connector is electrically engaged with the headset. The headset is stored in the carrying device during periods of non-use with a point-of-access externally accessible. The earpiece and microphone can be pulled out whenever needed. The headset has a cord-winder to receive the retractable cord to be included in the same unit of the carrying device.

### DRAWINGS—FIGURES

FIG. 1 shows the front view of a cellular phone according to the present invention.

FIG. 2 is the side view of the cellular phone illustrated in FIG. 1.

FIG. 3 is a view of the cellular phone illustrated in FIG. 1 when the hands-free headset is in use.

FIG. 4 shows an isometric view of a cellular phone holster according to the present invention.

FIG. 5 shows a connector extended from the holster body by a cable.

FIG. 6 shows an embodiment of cellular phone holster with two connectors

### DRAWINGS—REFERENCE NUMERALS

1 Cellular phone

2 Earpiece

3 Microphone

4 Cord-winder

5 Cord

6 Holster body

7 First connector, to connect the headset outlet of a cellular phone

8 Headset storage

9 Opening of headset storage

10 The portion that allows externally access to the earpiece

11 The cable extending the connector from the holster body

12 Second connector, to connect a headset

### DETAILED DESCRIPTION OF THE INVENTION

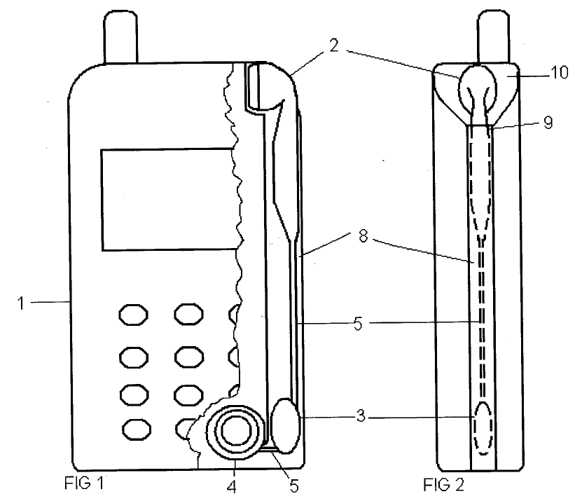

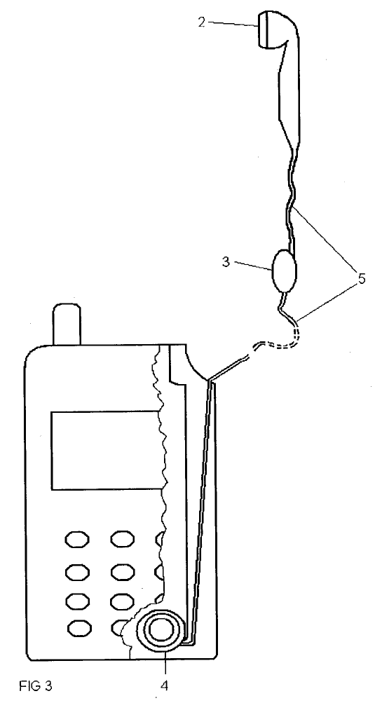

A preferred embodiment of the cellular phone of the present invention is illustrated in FIG. 1, FIG. 2, and FIG. 3. As shown, the cellular phone 1 has a built in hands-free headset comprising an earpiece 2, a microphone 3, a cord 5, and a cord-winder 4. The cord-winder 4 is mechanically affixed inside the cellular phone body.

FIG. 1 and FIG. 2 show the cellular phone when the headset is not in use. During this period, a section of the earpiece 2 is revealed on the surface of the cellular phone. The design of portion 10 of the cellular phone body enables external access to the earpiece 2. The opening 9 is predetermined in size so that the cord 5 and microphone 3 can easily slide in and out but only a portion of the earpiece 2 can fit in.

FIG. 3 shows the cellular phone with the carpiece 2 and the microphone 3 in use. The cord-winder 4 is always fixed inside the cellular phone 1. In a preferred embodiment, the cellular phone is configured such that when the earpiece 2 is pulled out of the phone, an incoming call is automatically connected without pressing any button. It is also preferred that when the headset is rewound to its embedded position, a call is automatically terminated.

In another preferred embodiment (not shown in the figures), the headset is hidden entirely inside the cellular phone. On the surface of the cellular phone, there is a button configured to pop out a portion of the headset.

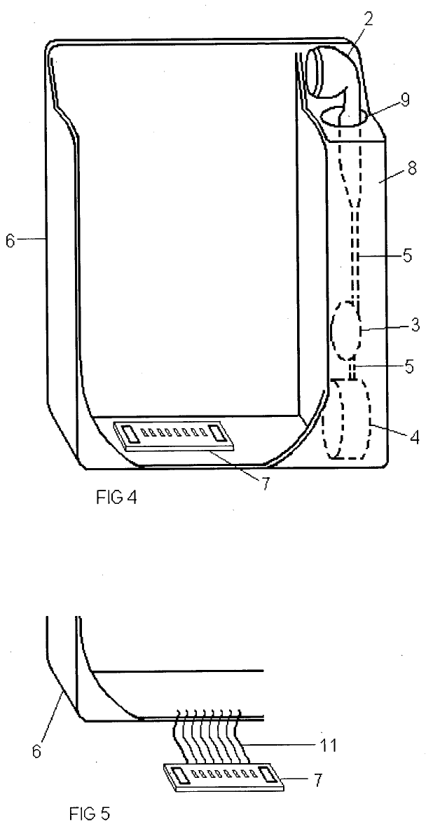

FIG. 4 shows a preferred embodiment of a cellular phone holster, as a carrying device for a cellular phone. The connector 7 is to couple with the headset outlet of a cellular phone; meanwhile, the headset is hardwired to the connector 7. In this embodiment the connector 7 is directly affixed to the predetermined position of the holster. Whenever the cellular phone is properly placed in the holster, this connector 7 and the headset outlet of the cellular phone are connected and electrically engaged. The heads-set storage box 8 stores the whole heads-set except one portion of the earpiece 2. A user can pull the earpiece and microphone out by pulling this portion of the earpiece 2. The cord-winder 4 is affixed statically in the storage box 8. The opening 9 is predetermined in size so that the cord and the microphone can easily slide in and out but the earpiece is blocked from entirely entering the opening. In a preferred embodiment, the holster is configured such that when the earpiece 2 is pulled out of the holster, an incoming call is automatically connected without pressing any button. It is also preferred that when the headset is rewound to its embedded position, a call is automatically terminated.

FIG. 5 shows a portion of another preferred embodiment of a cellular phone holster. The connector 7 is extended from the holster body by a cable 11. This configuration provides flexibility in connecting the connector 7 to the headset outlet of a cellular phone.

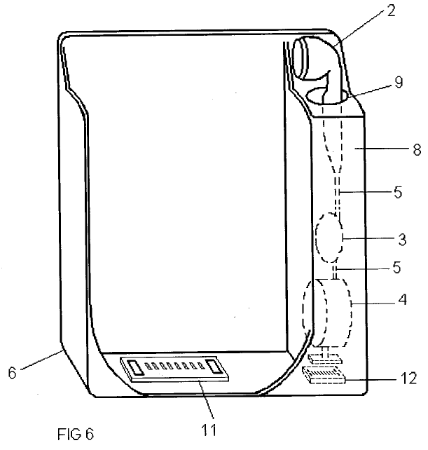

FIG. 6 shows another preferred embodiment, in which there are two connectors, one to couple with the headset outlet of a cellular phone, the other being attached by a stand-alone headset. This headset is able to fit in the headset storage box with one portion externally accessible. The earpiece and microphone can be pulled out of the storage while the cord-winder of the headset is constrained inside the holster. In the drawing of FIG. 6, the headset is intentionally detached from the second connector in order to reveal the second connector, however, in a properly set up holster, the headset is attached to the second connector. This embodiment provides flexibility for the headset since the headset can be detached from the carrying device body when needed.

In another preferred embodiment (not shown in the figures), the headset is hidden entirely inside the holster. On the surface of the holster, there is a button configured to pop out a portion of the headset.

The earpiece and microphone are separated pieces in the figures, but they can be formed into one piece as well. There can also be a call-answer button on the headset.

In all embodiments discussed above, cord-winder 4 urges the cord to be rewound when the cord is pulled out. Although not illustrated in the figures, it is also preferable to have a hatch for the cord-winder that stops the cord-winder from rewinding the cord. Also, a button on the cellular phone or the holster controls the hatch. When the button is pressed, the hatch is released and the cord is rewound if it is pulled out. It can also be configured that the user releases the hatch by pulling the cord to its longest extension.

Advantages

From the description above, a number of advantages of this invention become evident:

(a) A hands-free headset is always ready-to-use. In the cellular phone of my invention, the cellular phone always has the headset set up since the headset is hardwired in. In my invented carrying device, after properly placing a cellular phone into the carrying device, the headset is electrically connected to the phone as well.

(b) Carrying the headset is convenient. The headset is hidden in the cellular phone or in the carrying device during periods of non-use.

(c) Using and storing the headset is convenient. A point-of-access to retrieve the headset from the storage is externally accessible. By releasing the cord, the headset is rewound into the storage.

(d) The cellular phone or the case/holster/holder is more compact than other solutions for providing hands-free headset with the similar convenience. The added convenience does not significantly affect the exterior of the device.

Conclusion, Ramifications, and Scope

With this invention, it is clearly demonstrated that the cellular phone and the carrying device for a cellular phone provides a ready-to-use hands-free headset. This readiness is provided in a convenient and aesthetic fashion. The readiness of a hands-free headset promotes the use of hands-free option when appropriate.

Although the description above contains many specificities, these should not be construed as limiting the scope of the invention but as merely providing illustrations of some of the presently preferred embodiments of this invention. For example, the heads-set can be configured in other shapes, and stored in the cellular phone or in the carrying device in other ways; the cellular phone and the carrying device can be configured in other shapes and structures, etc.

Thus the scope of the invention should be determined by the appended claims and their legal equivalents, rather than by the examples given.

I claim:

1. A portable electronic device with cellular phone capability having a built-in hands-free headset, comprising:
a. a portable electronic device with cellular phone capability configured to have room for a hands-free headset's storage, and
b. a hands-free headset storable into the body of said device, comprising
(a) an earpiece,
(b) a microphone,
(c) a retractable cord operably associated with said earpiece and said microphone, said cord hardwired and electrically connected to said device,
(d) a cord-winder fixed inside the body of said device, said cord-winder configured to receive said cord for storage and to allow said cord to be pulled out, and
(e) an accessing point to said headset externally accessible,
wherein said headset is stored in the body of said device during periods of non-use of said headset, wherein said earpiece and said microphone is configured to be pulled out of said device for telephone conversation.

2. A portable electronic device with cellular phone capability according to claim 1, wherein said earpiece and microphone are formed into one piece.

3. A cellular phone-carrying device with built-in hands-free headset, comprising:
a. a carrying device having room for a hands-free headset's storage, said carrying device configured for a portable electronic device with cellular phone capability,
b. a connector positioned inside the body of said carrying device and mechanically connected to said carrying device by a connection means, said connector configured to couple with the headset outlet of a portable electronic device with cellular phone capability, and
c. a hands-free headset storable into the body of said carrying device, comprising
(a) an earpiece,
(b) a microphone,
(c) a retractable cord operably associated with said earpiece and said microphone, said cord electrically connected to said connector,
(d) a cord-winder constrained inside the body of said carrying device, said cord-winder configured to receive said cord for storage and to allow said cord to be pulled out, and
(e) an accessing point to said headset externally accessible,
wherein said headset is stored in said carrying device during periods of non-use of said headset, and wherein said earpiece and said microphone is configured to be pulled out of the body of said carrying device for telephone conversation.

4. A carrying device according to claim 3, wherein said earpiece and microphone are formed into one piece.

5. A carrying device according to claim 3, wherein said connector is connected to the body of said carrying device by a cable.

6. A carrying device according to claim 4, wherein said connector is connected to the body of said carrying device by a cable.

7. A cellular phone-carrying device with attached hands-free headset, comprising:
a. a carrying device having room for a hands-free headset's storage, said carrying device configured for a portable electronic device with cellular phone capability,
b. a first connector positioned in the body of said carrying device and mechanically connected to said carrying device by a connection means, said first connector configured to couple with the headset outlet of a portable electronic device with cellular phone capability,
c. a second connector positioned in the body of said carrying device and mechanically connected to the body of said carrying device by a connection means, said second connector electrically connected to said first connector, and
d. a hands free headset storable into the body of said carrying device, said headset comprising
(a) an earpiece,
(b) a microphone,
(c) a cord operably associated with said earpiece and said microphone, said cord attachable to and electrically engagable with said second connector,
(d) a cord-winder constrainable inside the body of said carrying device, said cord-winder configured to receive said cord for storage and to allow said cord to be pulled out, and
(e) an accessing point to said headset externally accessible,
wherein said cord is releasably attached to said second connector, wherein said headset is stored in said carrying device during periods of non-use of said headset, and wherein said earpiece and said microphone is configured to be pulled out of the body of said carrying device for telephone conversation.

8. A carrying device according to claim 7, wherein said earpiece and microphone are formed into one piece.

9. A carrying device according to claim 7, wherein at least one of said connectors is connected to the body of said carrying device by a cable.

10. A carrying device according to claim 8, wherein at least one of said connectors is connected to the body of said carrying device by a cable.
